(19) United States
(12) Patent Application Publication
(10) Pub. No.: US 2020/0118141 A1
(43) Pub. Date: Apr. 16, 2020

(54) AUTOMATED COMMUNICATION PREFERENCE SETTING IN A CUSTOMER RELATIONSHIP MANAGEMENT (CRM) APPLICATION

(71) Applicant: SugarCRM Inc., Cupertino, CA (US)

(72) Inventors: Steve Byrne, Vancouver, WA (US); Rich Green, Los Altos Hills, CA (US); Eonju Lee, Cupertino, CA (US); Joseph Mao, Sunnyvale, CA (US); Brian Ng, Santa Clara, CA (US); Andreas Sandberg, Pacifica, CA (US); Zac Sprackett Sprackett, Kanata (CA)

(21) Appl. No.: 16/157,044

(22) Filed: Oct. 10, 2018

(51) Int. Cl. G06Q 30/00; G06Q 50/00

(52) U.S. Cl. CPC G06Q 30/01; H04L 51/32; G06Q 50/01

(57) ABSTRACT

Embodiments of the invention provide a method, system and computer program product for automated communication preference setting in a customer relationship management (CRM) application. The method includes establishing a communicative connection between a CRM application and different feeds of different social media sites, storing customer information with customer social media profiles and monitoring posts of the customer social media profiles in each of the social media sites. The method further includes aggregating in a log a total amount of posts for each customer social media profile for each social media site over a specified period of time and determining a threshold amount of postings for the period of time. The method finally includes setting a customer social media communication preference to the customer social media profile with the most posts if the determined threshold amount is exceeded by the log in at least one of the social media sites.

### BACKGROUND OF THE INVENTION

### Field of the Invention

The present invention relates to CRM and more particularly to customer communication preferences in CRM.

### Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

CRM provides an indispensable tool for product and service providers to manage the customer experience before, during and long after the sale has closed. The ability to manage all aspects of the customer experience largely depends upon maintaining a line of communication between the customer and the product or service provider. Yet, in many cases, an unsatisfied customer will not contact the product or service provider post-sale despite a perceived or actual failure in a purchased product or service. Thus, it is imperative that the product or service provider contacts the customer on a regular basis to keep their customer satisfied.

Oftentimes, a customer will not respond to product or service provider because the product or service provider attempts to contact the customer through the wrong communication channel. Many customers prefer to communicate through a specific communication channel such as a specific social media web sites, phone calls through a specific number, text message through a specific number or e-mail through a specific e-mail address. However, it is up to the product or service provider to guess how best to contact the customer. Thus, the product or service provider may fail to communicate with a customer or overburden the customer by contacting the customer through too many communication channels or the wrong communication channels.

### BRIEF SUMMARY OF THE INVENTION

Embodiments of the present invention address deficiencies of the art in respect to customer communication in CRM and provide a novel and non-obvious method, system and computer program product for automated customer communication preference setting in a CRM application. In an embodiment of the invention, a method for automated communication preference setting in a CRM application includes establishing a communicative connection between a CRM application executing in memory of a host computing system and one or more different feeds of respectively different social media web sites over a computer communications network, storing one or more customer information with one or more customer social media profiles in memory of the host computing system and monitoring posts of the one or more customer social media profiles in each of the social media web sites. The method further includes aggregating in a log a total amount of posts of for each customer social media profile for each social media web sites over a specified period of time and determining a threshold amount of postings for the specified period of time. Finally, the method includes if the aggregated log of the total amount of posts of the customer social media profile in at least one of the social media websites exceeds the determined threshold amount, setting a customer social media communication preference to the customer social media profile for the social media web site with the most amount of posts.

In one aspect of the embodiment, the method further includes if the aggregated log is below a threshold setting, setting a customer communication preference to a customer communication channel stored in the customer information. In another aspect of the embodiment, the customer communication channels include phone call, text message and email. In yet another aspect of the embodiment, the method further includes establishing a communicative connection between the CRM application executing in memory of the host computing system and one or more communication channels over the computer communications network, storing one or more customer communication channels associated with the one or more customer contact information and monitoring different customer communications in the one or more communication channels. The method in this aspect of the embodiment even further includes aggregating in a second log a total amount of customer communications for each of the customer communication channels and setting the customer communication channel preference to the customer communication channel with the most amount of communications.

In another embodiment of the invention, a CRM data processing system is configured for automated communication preference setting. The system includes a host computing system comprising one or more computers each with memory and at least one processor. The system also includes a CRM application executing the memory of the host computing system. Finally, the system includes an automated communication preference setting module coupled to the CRM application. The module includes program code enabled to establish a communicative connection between the CRM application and one or more different feeds of respectively different social media web sites over a computer communications network, to store one or more customer information with one or more customer social media profiles in memory of the host computing system, and to monitor posts of the one or more customer social media profiles in each of the social media web sites. The module further includes program code enabled to aggregate in a log a total amount of posts of for each customer social media profile for each social media web sites over a specified period of time and to determine a threshold amount of postings for the specified period of time. Finally, the module includes program code if the aggregated log of the total amount of posts of the customer social media profile in at least one of the social media websites exceeds the determined threshold amount, to set a customer social media communication preference to the customer social media profile for the social media web site with the most amount of posts.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for automated communication preference setting in a CRM application;

FIG. 2 is a schematic illustration of a CRM data processing system configured for automated communication preference setting; and,

FIG. 3 is a flow chart illustrating a process for automated communication preference setting in a CRM application.

### DETAILED DESCRIPTION OF THE INVENTION

Embodiments of the invention provide for automated communication preference setting in a CRM application. In accordance with an embodiment of the invention, client information with their associated communication information, such as e-mails and phone numbers, as well as their associated social media profiles are stored in a database coupled to a CRM application. The CRM application monitors different feeds of different social media web sites and aggregates the amount of posts for each of the social media profiles associated with each one of the customers in the database. The CRM application also aggregates the amount of communications for each customer based on the type of communication and source of the communication. A threshold amount of postings over a specified period of time is determined in order to determine if the user is generally active on a social media profile. If the amount of posts by a customer's social media profile exceeds the threshold amount over a specified period of time, the user social media preference is automatically set to the social media profile with the highest amount of posts. The same threshold determination can be repeated for the type of communication and source of communication for the customer to determine a separate communication preference for phone call, text message or e-mail. Furthermore, the total communication preference may be a determination of the most amount of communications through phone call, text message, email, and each of the customer's social media profiles.

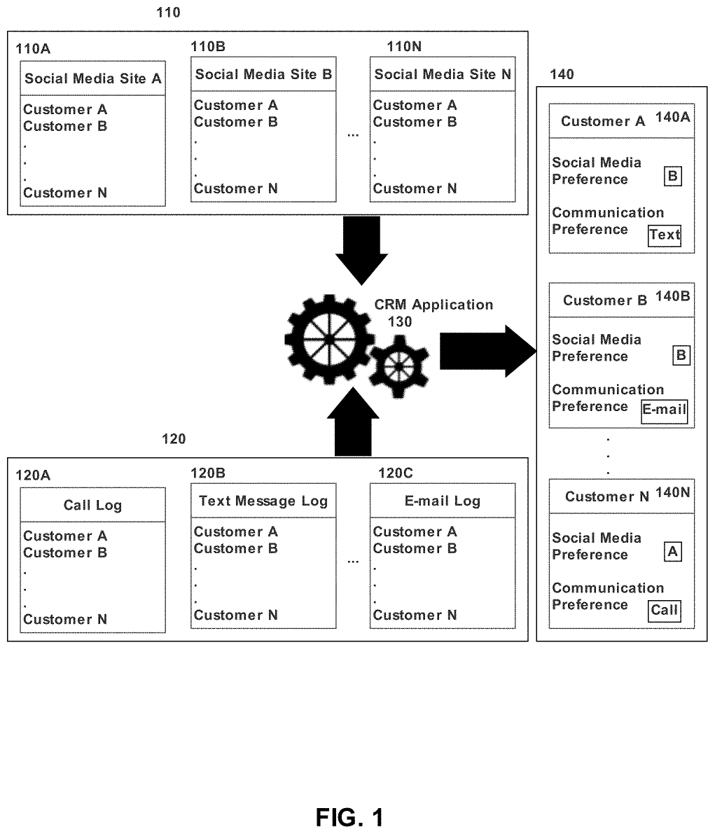

In further illustration, FIG. 1 is a pictorial illustration of automated communication preference setting in a CRM application. As shown in FIG. 1, a CRM application 130 is in communication with various social media web sites 110A, 110B, 110N and communication channels 120A, 120B, 120N used by the end user of the CRM application 130 to communicate with their customers. The customers of the CRM application 130 are stored in a database of the CRM application 130 with their various social media profiles in each of the social media websites. The customer's social media posts 110A, 110B and 110N are monitored by the CRM application 130. The customer social media posts are aggregated in a log to determine how many posts a specific customer posts in each of their social media profiles 110A, 110B and 110N over a specified period of time. If the values of the log for at least one of the social media profiles exceed the threshold value over the specified period of time, the customer's social media preference, as shown in 140A, 140B and 140C, is presented to the end user of the CRM application. The threshold value of posts may be input by the end user of the CRM application 130 or may be determined based on variances of an average value of posts by the various customers of the CRM application 130.

The customer communications 120A, 120B and 120C with the end users of the CRM application 130 are also stored in a database 120 of the CRM application. The customer communications are aggregated in a log based on the type of communication 120A, 120B, 120N for each of the customers to determine which type of communication the customer uses the most. The customer communication preference for each customer is then set based on the type and source of communication used by the customer and presented to the end user of the CRM application 130, as shown in 140A, 140B and 140N. The amount of total communications may also be used to determine the threshold amount as mentioned above. Furthermore, there may be an overall communication preference presented to the end user of the CRM application, not shown in 140, that determines an overall communication preference between the customer communication preference and social media communication preference.

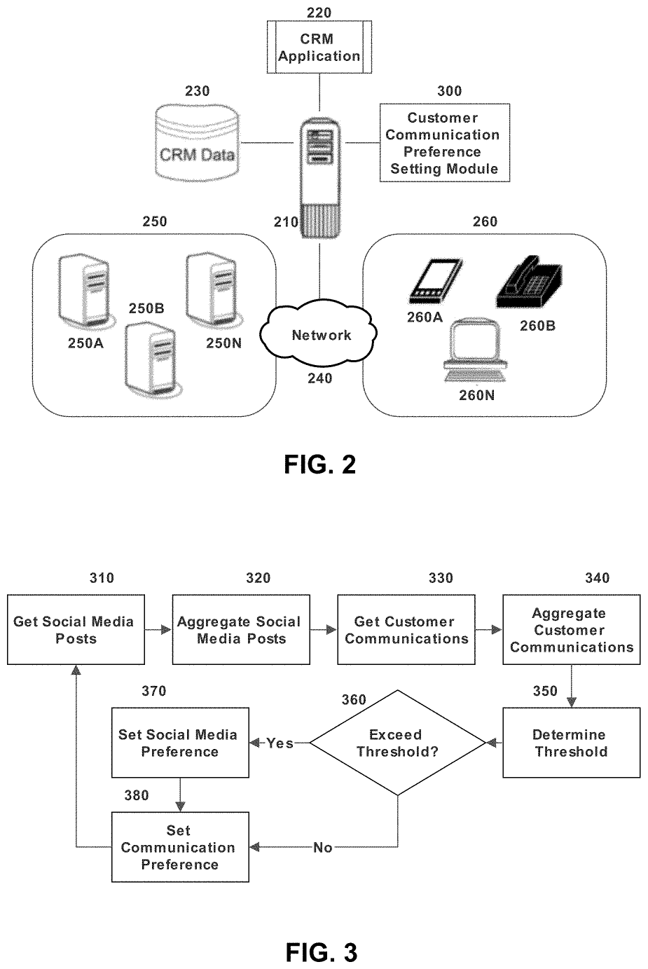

The process described in FIG. 1 is implemented in a data processing system. In further illustration, FIG. 2 schematically shows a CRM data processing system configured for automated communication preference setting. The system includes a host computing system 210 that includes one or more computers, each with memory and at least one processor. The host computing system 210 supports the operation of a CRM application 220 providing an interface through which different end users create, access, modify and delete CRM data in a CRM data store 230. In this regard, the end users access the CRM application 220 over computer communications network 240. The customer information with associated customer communication information, such as phone numbers for calling or texting and email addresses, as well as the customer social media profiles for various social media web sites are stored in the CRM data store 230.

The host computing system 210 also is communicatively coupled over computer communications network 240 to a selection 250 of different social media web site servers 250A, 250B, 250N, as well as customer phones and computing devices 260 including phones, personal computers 260N and mobile devices 260A, 260B such as laptop computers, smart phones and tablet computers. Each of the different social media Web site servers 250A, 250B, 250N supports the collection and publication of different communications by different individuals in different feeds of different social media Web site servers 250A, 250B, 250N providing different social media Web sites. Importantly, an automated communication preference setting module 300 executes in the memory of the host computing system 210 in conjunction with the CRM application 220.

The automated communication preference setting module 300 includes computer program code that when executed in the memory of the host computing system, monitors the communications of the different feeds of the different social media Web sites provided by the different social media Web site servers 250A, 250B, 250N, as well as the e-mail, messages, and phone communications between the customer phones and computing devices 260 and the end users of the CRM application 220. The automated communication preference setting module 300 then aggregates the social media posts by each of the customer social media profiles in each of the social media web sites in a log to determine the social media profile with the maximum amount of posts over a specified period of time. The automated communication preference setting module 300 then determines the customer social media communication preference based on which social media web site the customer posts in the most over a specified period of time. The automated communication preference setting module 300 may also aggregate the amount of customer communications through the various other communication channels 260 in order to determine a customer communication preference. Additionally, the customer communication preference may be separate from the customer social media preference or the two may be combined

In even yet further illustration of the operation of the automated communication preference setting module 300, FIG. 3 is a flow chart illustrating a process for automated communication preference setting in a CRM application. Beginning in block 310, the social media posts of the customers of the CRM application are monitored by the CRM application in the various social media profiles and social media web sites that the CRM customers utilize. In block 320, the social media posts for each of the websites for each customer of the CRM application are aggregated in logs. In block 330, the customer communications in the various customer communication channels, such as phone calls, text messages and e-mail and separate phone numbers and e-mail addresses associated with the customer, are also monitored. In block 340, the customer communications are aggregated in logs specific to the type of communications and source, such as specific number or e-mail address, for each of the customers.

In block 350, a threshold amount of social media posts is determined in order to determine whether the customer is active enough on social media to contact through social media. In block 360, it is determined if the amount of social media posts for a specific user in a specific social media web site or profile exceeds that threshold value over a specified period of time. If so, in block 370, the social media preference is set to the social media profile of the customer with the most posts in the aggregated log. If the amount does not exceed the threshold value over a specified period of time or after the social media preference has been set, in block 380, the communication preference is set for the customer based on which type and source of communication the customer uses the most. There may be a total communication preference based on the combined social media preference and communication preference of the customer or separate communication preference for social media and general communications.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for automated communication preference setting in a customer relationship management (CRM) application, the method comprising:
establishing a communicative connection between a CRM application executing in memory of a host computing system and one or more different feeds of respectively different social media web sites over a computer communications network;
storing one or more customer information with one or more customer social media profiles in memory of the host computing system;
monitoring posts of the one or more customer social media profiles in each of the social media web sites;
aggregating in a log a total amount of posts of for each customer social media profile for each social media web sites over a specified period of time;
determining a threshold amount of postings for the specified period of time; and
if the aggregated log of the total amount of posts of the customer social media profile in at least one of the social media websites exceeds the determined threshold amount, setting a customer social media communication preference to the customer social media profile for the social media web site with the most amount of posts.

2. The method of claim 1, further comprising:
if the aggregated log is below a threshold setting, setting a customer communication preference to a customer communication channel stored in the customer information.

3. The method of claim 2, wherein the customer communication channels include phone call, text message and email.

4. The method of claim 1, further comprising:
establishing a communicative connection between the CRM application executing in memory of the host computing system and one or more communication channels over the computer communications network;
storing one or more customer communication channels associated with the one or more customer contact information;
monitoring different customer communications in the one or more communication channels;
aggregating in a second log a total amount of customer communications for each of the customer communication channels; and
setting the customer communication channel preference to the customer communication channel with the most amount of communications.

5. The method of claim 4, wherein the customer communication channels include phone call, text message and email.

6. A customer relationship management (CRM) data processing system configured for automated communication preference setting, the system comprising:
a host computing system comprising one or more computers each with memory and at least one processor;
a CRM application executing the memory of the host computing system; and,
an automated communication preference setting module coupled to the CRM application, the module comprising program code enabled to establish a communicative connection between the CRM application and one or more different feeds of respectively different social media web sites over a computer communications network, to store one or more customer information with one or more customer social media profiles in memory of the host computing system, to monitor posts of the one or more customer social media profiles in each of the social media web sites, to aggregate in a log a total amount of posts of for each customer social media profile for each social media web sites over a specified period of time, to determine a threshold amount of postings for the specified period of time, and if the aggregated log of the total amount of posts of the customer social media profile in at least one of the social media websites exceeds the determined threshold amount, to set a customer social media communication preference to the customer social media profile for the social media web site with the most amount of posts.

7. The system of claim 6, wherein the module further comprises program code enabled if the aggregated log is below a threshold setting, to set a customer communication preference to a customer communication channel stored in the customer information.

8. The system of claim 7, wherein the customer communication channels include phone call, text message and email.

9. The system of claim 6, wherein the module further comprises program code enabled to establish a communicative connection between the CRM application executing in memory of the host computing system and one or more communication channels over the computer communications network, to store one or more customer communication channels associated with the one or more customer contact information, to monitor different customer communications in the one or more communication channels, to aggregate in a second log a total amount of customer communications for each of the customer communication channels, and to set the customer communication channel preference to the customer communication channel with the most amount of communications.

10. The system of claim 9, wherein the customer communication channels include phone call, text message and email.

11. A computer program product for automated communication preference setting in a customer relationship management (CRM) application, the computer program product comprising a computer readable storage medium having program instructions embodied therewith, the program instructions executable by a device to cause the device to perform a method comprising:
establishing a communicative connection between a CRM application executing in memory of a host computing system and one or more different feeds of respectively different social media web sites over a computer communications network;
storing one or more customer information with one or more customer social media profiles in memory of the host computing system;
monitoring posts of the one or more customer social media profiles in each of the social media web sites;
aggregating in a log a total amount of posts of for each customer social media profile for each social media web sites over a specified period of time;
determining a threshold amount of postings for the specified period of time; and
if the aggregated log of the total amount of posts of the customer social media profile in at least one of the social media websites exceeds the determined threshold amount, setting a customer social media communication preference to the customer social media profile for the social media web site with the most amount of posts.

12. The computer program product of claim 11, wherein the method further comprises:
if the aggregated log is below a threshold setting, setting a customer communication preference to a customer communication channel stored in the customer information.

13. The computer program product of claim 12, wherein the customer communication channels include phone call, text message and email.

14. The computer program product of claim 11, wherein the method further comprises:
establishing a communicative connection between the CRM application executing in memory of the host computing system and one or more communication channels over the computer communications network;
storing one or more customer communication channels associated with the one or more customer contact information;
monitoring different customer communications in the one or more communication channels;
aggregating in a second log a total amount of customer communications for each of the customer communication channels; and
setting the customer communication channel preference to the customer communication channel with the most amount of communications.

15. The computer program product of claim 14, wherein the customer communication channels include phone call, text message and email.
